(19) United States
(12) Patent Application Publication
(10) Pub. No.: US 2014/0195133 A1
(43) Pub. Date: Jul. 10, 2014

(54) VEHICLE BRAKING FORCE CONTROL DEVICE AND METHOD FOR CONTROLLING VEHICLE BRAKING FORCE

(71) Applicants: Hidehisa Kato, Susono-shi (JP); Takayuki Goto, Atsugi-shi (JP); Atsushi Sone, Toyota-shi (JP); Akifumi Doura, Kariya-shi (JP)

(72) Inventors: Hidehisa Kato, Susono-shi (JP); Takayuki Goto, Atsugi-shi (JP); Atsushi Sone, Toyota-shi (JP); Akifumi Doura, Kariya-shi (JP)

(73) Assignees: ADVICS CO., LTD., Kariya-city, Aichi-pref. (JP); TOYOTA JIDOSHA KABUSHIKI KAISHA, Toyota-shi, Aichi-ken (JP)

(21) Appl. No.: 14/237,797

(22) PCT Filed: Aug. 9, 2012
(86) PCT No.: PCT/IB2012/001536

§ 371 Date: Feb. 27, 2014

(30) Foreign Application Priority Data
Aug. 10, 2011 (JP) 2011-175273

(51) Int. Cl. B60L 7/26; B60T 8/176

(52) U.S. Cl. CPC B60L 7/26; B60T 8/176
USPC 701/78

(57) ABSTRACT

A vehicle braking force control device includes a controller that controls braking force of a wheel by controlling friction braking force generated by a friction braking device and regenerative braking force generated by regenerative braking devices and that performs anti-skid control based on a requested amount of braking force reduction by controlling the friction braking force and reducing the regenerative braking force by an amount of regenerative braking force reduction. The controller sets a target change amount of the friction braking force based on the requested amount of braking force reduction and the amount of regenerative braking force reduction, and controls the friction braking force based on the target change amount when the controller reduces the regenerative braking force by the amount of regenerative braking force reduction.

### BACKGROUND OF THE INVENTION

1. Field of the Invention

The present invention relates to a vehicle braking force control device and a method for controlling vehicle braking force, and particularly to a braking force control device and a method for controlling vehicle braking force that are applied to a vehicle in which regenerative braking is performed.

2. Description of Related Art

Anti-skid control (ABS control) has conventionally been known in which when any of the wheels is subject to excessive slip during braking, the braking force of the particular wheel is lowered to reduce the slip during braking. Such anti-skid control is also performed in a vehicle in which regenerative braking is performed.

For example, Japanese Patent Application Publication No. 2005-304100 (JP 2005-304100 A) below describes a braking force control device that achieves a request lowering amount of braking force on the basis of the anti-skid control by lowering a regenerative braking force and achieves a request increasing amount of braking force on the basis of the anti-skid control by increasing a friction braking force.

On the other hand, it is difficult to control regenerative braking force on each wheel with good response. Therefore, in a general braking force control device, when the conditions for starting the anti-skid control are satisfied, the regenerative braking force is lowered to zero, and friction braking force is controlled according to the slip during braking.

There are cases that the anti-skid control is performed such that the braking force on the wheel is temporarily lowered by a target lowering amount, thereafter sustained at constant force, and gradually increased when the slip during braking starts decreasing. In such a case, the target lowering amount is computed on the basis of the slip during braking. In the conventional braking force control device, the friction braking force is lowered by the target lowering amount, and further the regenerative braking force is lowered to zero.

Accordingly, when the regenerative braking force immediately before the anti-skid control starts is large, the braking force on the wheel is excessively lowered, and due to that the braking force on the wheel may become excessively small. Further, when the target lowering amount is set smaller than the amount computed on the basis of the slip during braking to prevent such a problem, in the case that the regenerative braking force immediately before the anti-skid control starts is small, the braking force on the wheel is not sufficiently lowered, and this may result in ineffective reduction in the slip during braking.

### SUMMARY OF THE INVENTION

The present invention provides a vehicle braking force control device and a method for controlling vehicle braking force that lower friction braking force to achieve effective reduction in slip during braking regardless of a request lowering amount of braking force on the basis of anti-skid control or regenerative braking force.

A first aspect of the invention is a vehicle braking force control device that includes a controller that controls braking force of a wheel by controlling friction braking force generated by a friction braking device and regenerative braking force generated by regenerative braking devices and that performs anti-skid control based on a requested amount of braking force reduction by controlling the friction braking force and reducing the regenerative braking force by an amount of regenerative braking force reduction, wherein: the controller sets a target change amount of the friction braking force based on the requested amount of braking force reduction and the amount of regenerative braking force reduction; and the controller controls the friction braking force based on the target change amount when the controller reduces the regenerative braking force by the amount of regenerative braking force reduction.

According to the above configuration, it is possible to set an appropriate target change amount of the friction braking force for the anti-skid control compared to the case in a conventional braking force control device that controls the friction braking force during the anti-skid control without consideration of the regenerative braking force.

The controller may set the target change amount according to whether the requested amount of braking force reduction is equal to or larger than the amount of regenerative braking force reduction.

According to the above configuration, the target change amount of the friction braking force can be set according to the comparison result between the amount of regenerative braking force reduction and the requested amount of braking force reduction. Accordingly, it is possible to set an appropriate target change amount of the friction braking force for the anti-skid control compared to the case in a conventional braking force control device that controls the friction braking during the anti-skid control without consideration of the regenerative braking force.

If the requested amount of braking force reduction is smaller than the amount of regenerative braking force reduction, the controller may set the target change amount to an increasing amount that is equal to or smaller than a difference between the amount of regenerative braking force reduction and the requested amount of braking force reduction and that is equal to or larger than zero and may increase the friction braking force by the increasing amount during the anti-skid control.

According to the above configuration, increase in the friction braking force can cover the shortage of the braking force when the braking force is reduced by an amount larger than the requested amount of braking force reduction due to the reduction of the regenerative braking force. Accordingly, it is possible to prevent the reduction in the braking force by an amount larger than the requested amount of braking force reduction and thus the reduction in the deceleration of the vehicle when the requested amount of braking force reduction is smaller than the amount of regenerative braking force reduction.

If the requested amount of braking force reduction is equal to or larger than the amount of regenerative braking force reduction, the controller may set the target change amount to a lowering amount that is a difference between the requested amount of braking force reduction and the amount of regenerative braking force reduction and may reduce the friction braking force by the lowering amount during the anti-skid control.

According to the above configuration, the requested amount of braking force reduction can be achieved without excess or shortage by reducing the regenerative braking force by the amount of regenerative braking force reduction and reducing the friction braking force by the target change amount. This is because the sum of the amount of regenerative braking force reduction and the target change amount of the friction braking force equals the requested amount of braking force reduction.

The controller may set the target change amount so that a sum of the amount of regenerative braking force reduction and the target change amount is equal to the requested amount of braking force reduction.

According to the above configuration, the requested amount of braking force reduction in the anti-skid control can be achieved without excess or shortage by reducing the regenerative braking force and controlling the friction braking force based on the target change amount. Accordingly, it is possible to set an appropriate target change amount of the friction braking force for the anti-skid control compared to the case in a conventional braking force control device that controls the friction braking force during the anti-skid control without consideration of the regenerative braking force.

If the requested amount of braking force reduction is smaller than the amount of regenerative braking force reduction, the controller may increase the friction braking force by the target change amount during the anti-skid control. On the other hand, if the requested amount of braking force reduction is equal to or larger than the amount of regenerative braking force reduction, the controller may reduce the friction braking force by the target change amount during the anti-skid control.

According to the above configurations, the friction braking force during the anti-skid control can be controlled appropriately according to the comparison result between the amount of regenerative braking force reduction and the requested amount of braking force reduction.

If the requested amount of braking force reduction is smaller than the amount of regenerative braking force reduction, the controller may change the target change amount to an increasing amount that is smaller than a difference between the amount of regenerative braking force reduction and the requested amount of braking force reduction and that is equal to or larger than zero and may increase the friction braking force by the increasing amount during the anti-skid control.

According to the above configuration, increase in the friction braking force can cover the shortage of the braking force when the braking force is reduced by an amount larger than the requested amount of braking force reduction due to the reduction of the regenerative braking force. Accordingly, it is possible to prevent the reduction in the braking force by an amount larger than the requested amount of braking force reduction and thus the reduction in the deceleration of the vehicle when the requested amount of braking force reduction is smaller than the amount of regenerative braking force reduction.

The controller may reduce the regenerative braking force to zero by reducing the regenerative braking force by the amount of regenerative braking force reduction during the anti-skid control.

According to the above configuration, the target change amount of the friction braking force can be set according to the comparison result between the requested amount of braking force reduction in the anti-skid control and the regenerative braking force generated at the time when the anti-skid control starts.

A second aspect of the invention is a method for controlling vehicle braking force, the method that includes: controlling braking force of a wheel by controlling friction braking force generated by a friction braking device and regenerative braking force generated by regenerative braking devices; setting a requested amount of braking force reduction that is requested in anti-skid control; setting an amount of regenerative braking force reduction by which the regenerative braking force is reduced during the anti skid control; setting a target change amount of the friction braking force based on the requested amount of braking force reduction and the amount of regenerative braking force reduction; and performing the anti-skit control by reducing the regenerative braking force by the amount of regenerative braking force reduction and controlling the friction braking force based on the target change amount. The target change amount may be set according to whether the requested amount of braking force reduction is equal to or larger than the regenerative force reduction amount. The target change amount may also be set so that a sum of the amount of regenerative braking force reduction and the target change amount is equal to the requested amount of braking force reduction.

According to the above configurations, it is possible to set an appropriate target change amount of the friction braking force for the anti-skid control compared to the case in a conventional braking force control device that controls the friction braking force during the anti-skid control without consideration of the regenerative braking force.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic block diagram showing an embodiment of a braking force control device in accordance with the present invention, which is applied to a vehicle in which a hybrid system is installed;

FIG. 2 is a flowchart showing a main routine of anti-skid control;

FIG. 3 is a flowchart showing a subroutine for computation of a target friction braking force reduction amount which is executed in step 100 in the flowchart shown in FIG. 2;

FIG. 4 is a flowchart showing a subroutine for controlling braking pressure which is executed in step 300 in the flowchart shown in FIG. 2;

FIG. 5 is a graph representing an example of changes in the friction braking force and the regenerative braking force in the embodiment in a case that the regenerative braking force remains when the anti-skid control starts and a target braking force reduction amount ΔFbti is equal to or larger than a reducible amount ΔFbrti of the regenerative braking force:

FIG. 6 is a graph representing an example of changes in the friction braking force and the regenerative braking force in a conventional braking force control device in a case that the regenerative braking force remains when the anti-skid control starts and the target braking force reduction amount ΔFbti is equal to or larger than the reducible amount ΔFbrti of the regenerative braking force;

FIG. 7 is a graph representing an example of changes in the friction braking force and the regenerative braking force in the embodiment when a slip-during-braking amount SLi is smaller than a third threshold value SL3 (solid line) and when the slip-during-braking amount SLi is equal to or larger than the third threshold value SL3 (broken line), in a case that the regenerative braking force remains when the anti-skid control starts, the target braking force reduction amount ΔFbti is smaller than the reducible amount ΔFbrti of the regenerative braking force; and

FIG. 8 is a graph representing an example of changes in the friction braking force and the regenerative braking force in the embodiment in a case that no regenerative braking force remains when the anti-skid control starts.

### DETAILED DESCRIPTION OF EMBODIMENTS

An embodiment of the present invention will be described hereinafter in detail with reference to attached drawings.

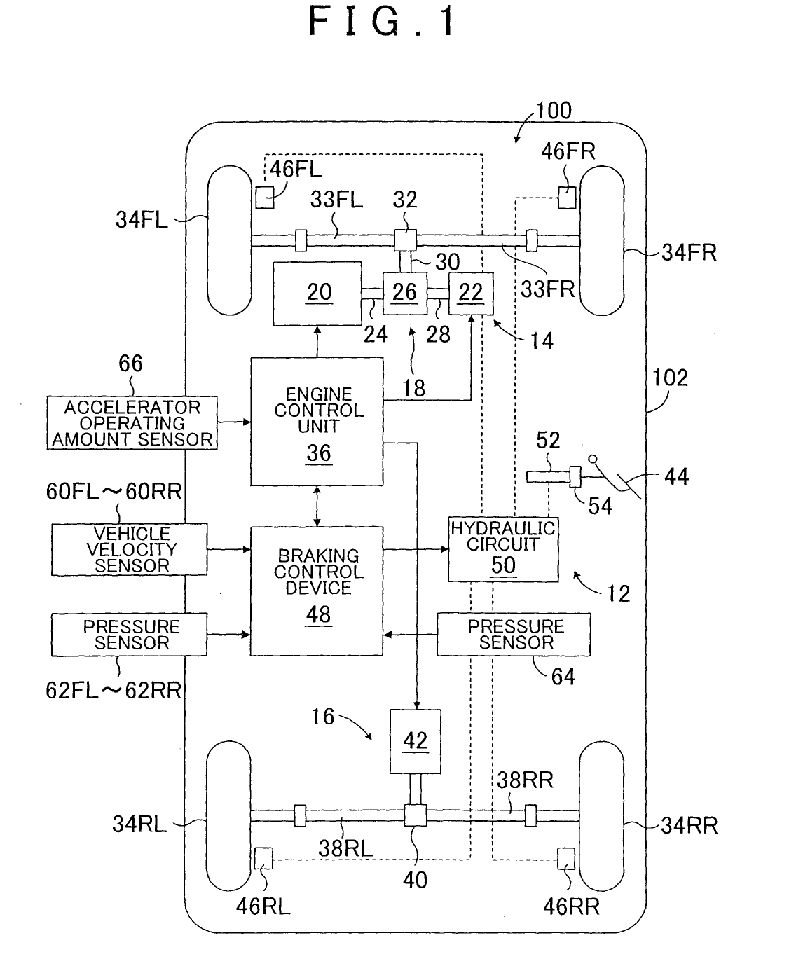

FIG. 1 is a schematic block diagram showing an embodiment of a braking force control device in accordance with the present invention, which is applied to a vehicle in which a hybrid system is installed.

In FIG. 1, a braking force control device 100 in accordance with this embodiment is installed in a vehicle 102. The braking force control device 100 includes a hydraulic friction braking device 12, a front wheel regenerative braking device 14, and a rear wheel regenerative braking device 16. Accordingly, the vehicle 102 is a vehicle in which the braking force on each wheel is controlled by cooperative control with friction braking by the friction braking device 12 and regenerative braking by the front wheel regenerative braking device 14 and the rear wheel, regenerative braking device 16.

Also in FIG. 1, a hybrid system 18 for driving the front wheels includes a gasoline engine 20 and a motor generator 22. An output shaft 24 of the gasoline engine 20 is coupled to an input shaft of a continuously variable transmission 26 including a clutch built therein. The input shaft of the continuously variable transmission 26 is also coupled to an output shaft 28 of the motor generator 22. Rotation of an output shaft 30 of the continuously variable transmission 26 is transmitted via front differential gears 32 to left and right front wheel axles 33FL and 33FR, thereby rotating left and right front wheels 34FL and 34FR.

The gasoline engine 20 and the motor generator 22 of the hybrid system 18 are controlled by an engine control unit 36 according to a depression amount of an accelerator pedal, which is not shown, depressed by a driver and a traveling state of the vehicle. The motor generator 22 functions as a generator (regenerative generator) of the front wheel regenerative braking device 14, and its function (regenerative braking) as the regenerative generator is also controlled by the engine control unit 36.

Also in FIG. 1, the rotation of left and right rear wheels 34 RL and 34 RR as driven wheels are transmitted to a motor generator 42 of the rear wheel regenerative braking device 16 via left and right rear wheel axles 38RL and 38RR and rear wheel differential gears 40. The regenerative braking by the motor generator 42 is controlled also by the engine control unit 36. Accordingly, the engine control unit 36 functions as a control device for the regenerative braking devices. The motor generator 42 is also used as an auxiliary drive source and may drive the left and right rear wheels 34RL and 34RR according to necessity.

The friction braking force on the left and right front wheels 34FL and 34

FR and the rear wheels 34RL and 34RR are, as described later in detail, controlled according to the control by a hydraulic circuit 50 of the braking pressure of wheel cylinders 46FL, 46FR, 46RL, and 46RR of the hydraulic friction braking device 12. The hydraulic circuit 50 is controlled by a braking control device 48 according to a braking operation amount of a brake pedal 44 operated by the driver. Although not shown, the hydraulic circuit 50 includes an oil reservoir, an oil pump, various valve devices and the like. The hydraulic circuit 50 is controlled by the braking control device 48 on the basis of the pressure inside a master cylinder 52 that changes according to the pedaling operation on the brake pedal 44 by the driver, in other words, master cylinder pressure Pm and the like.

The wheels 34FL to 34RR include wheel velocity sensors 60FR to 60RL for detecting corresponding wheel velocities Vwi (i=fl, fr, rl, rr) and pressure sensors 62FR to 62RL for detecting corresponding braking pressure Pi. The master cylinder 52 includes a pressure sensor 64 for detecting the master cylinder pressure Pm. A signal indicating the value detected by each of the sensors is input to the braking control device 48. The braking pressure Pi of each of the wheels may be estimated on the basis of actuations of the various valve devices of the hydraulic circuit 50.

The braking control device 48 computes a target braking force Fbvt on the whole vehicle on the basis of the master cylinder pressure Pm that represents the braking operation amount by the driver. The braking control device 48 computes target regenerative braking force Fbvrt and target friction braking force Fbvft on the basis of the target braking force Fbvt so that the sum of the target regenerative braking force Fbvrt on the whole vehicle and the target friction braking force Fbvft on the whole vehicle is equal to the target braking force Fbvt on the whole vehicle.

The braking control device 48 computes front wheel regenerative braking force (the target regenerative braking force to be distributed to the front wheels) Fbrtf and rear wheel target regenerative braking force (the target regenerative braking force to be distributed to the rear wheels) Fbrtr on the basis of the target regenerative braking force Fbvrt on the whole vehicle and a front-rear distribution ratio of the regenerative braking force. Further, the braking control device 48 computes target friction braking force Fbfti (i=fl, fr, rl, rr) on each of the wheels on the basis of the target friction braking force Fbvft on the whole vehicle and a front-rear distribution ratio of the friction braking force. Signals indicating the front wheel target regenerative braking force Fbrtf and the rear wheel regenerative braking force Fbrtr are output to the engine control unit 36.

The braking control device 48 estimates a vehicle velocity Vb on the basis of each of the wheel velocities Vwi by use of a known method and computes the slip-during-braking amount SLi (i=fl, fr, rl, rr) of each of the wheels. Each slip-during-braking amount SLi is the difference between an estimated vehicle velocity Vb and the corresponding vehicle velocity Vwi. When the slip-during-braking amount SLi is smaller than a first threshold value SL1 (a positive constant), the braking control device 48 controls the braking pressure Pi of each of the wheels so that the friction braking force of each of the wheels is equal to the target friction braking force Fbfti.

When the slip-during-braking amount SLi of a wheel becomes equal to or larger than the first threshold value SL1, the braking control device 48 gradually substitutes the friction braking force for the regenerative braking force of either the front wheels or rear wheels that includes the particular wheel whose slip-during-braking amount SLi equal to or larger than the first threshold value SL1. In other words, the braking control device 48 gradually reduces the target regenerative braking force Fbrti (i=fl, fr, rl, rr) of either the front wheels or rear wheels that includes the particular wheel until it becomes equal to zero and gradually increases the target friction braking force Fbti of either the front wheels or rear wheels that includes the particular wheel such that the reduction in the regenerative braking force is supplemented with the friction braking force.

When the slip-during-braking amount SLi of the particular wheel becomes equal to or larger than a second threshold value (a positive constant larger than SL1), the braking control device 48 sets the target regenerative braking force Fbrti of either the front wheels or rear wheels that includes the particular wheel to zero and performs the anti-skid control such that the friction braking force of the particular wheel is changed to reduce the slip during braking. The anti-skid control may be performed on the basis of a slip-during-braking ratio.

At the start of the anti-skid control, the braking control device 48 computes a target braking force reduction amount ΔFbti (i=fl, fr, rl, rr) of the particular wheel for reducing the slip-during-braking amount. When the regenerative braking force Fbri (i=fl, fr, rl, rr) of the particular wheel at the start of the anti-skid control is zero, the braking control device 48 reduces the braking pressure Pi of the particular wheel so that the braking force on the particular wheel is reduced by the target braking force reduction amount ΔFbti. On the other hand, when the regenerative braking force Fbri of the particular wheel at the start of the anti-skid control is not zero, the braking control device 48 subtracts the regenerative braking force Fbri of the particular wheel from the target braking force reduction amount ΔFbti of the particular wheel and thereby computes the corrected target braking force reduction amount ΔFbti. Further, the braking control device 48 reduces the braking pressure Pi of the particular wheel so that the friction braking force of the particular wheel is reduced by the corrected target braking force reduction amount ΔFbti.

An accelerator operating amount sensor 66 inputs a signal indicating the depression amount of the accelerator pedal to the engine control unit 36, and the continuously variable transmission 26 inputs a signal indicating its gear ratio to the engine control unit 36. The braking control device 48 inputs a signal indicating the front wheel target regenerative braking force Fbrtf and a signal indicating the rear wheel regenerative braking force Fbrtr to the engine control unit 36. When the driver performs a driving operation, the engine control unit 36 controls the gasoline engine 20 and the motor generator 22 on the basis of the depression amount of the accelerator pedal and the gear ratio of the continuously variable transmission 26 and thereby controls the driving force of the vehicle.

On the other hand, when the driver performs a braking operation, the engine control unit 36 controls the total driving force of the vehicle to zero. When the braking control device 48 inputs the signal representing the front wheel target regenerative braking force Fbrtf and the signal representing the rear wheel target regenerative braking force Fbrtr to the engine control unit 36, the engine control unit 36 controls the regenerative braking force on the basis of these signals. In other words, the engine control unit 36 controls the front wheel regenerative braking device 14 and the rear wheel regenerative braking device 16 so that the regenerative braking force Fbrf of the front wheel regenerative braking device 14 is equal to the target regenerative braking force Fbrtf and the regenerative braking force Fbrr of the rear wheel regenerative braking device 16 is equal to the target regenerative braking force Fbrtr.

The engine control unit 36 and the braking control device 48 may be devices of general configurations, each having a driving circuit and a microcomputer including CPU, ROM, RAM, and input-output device, for example.

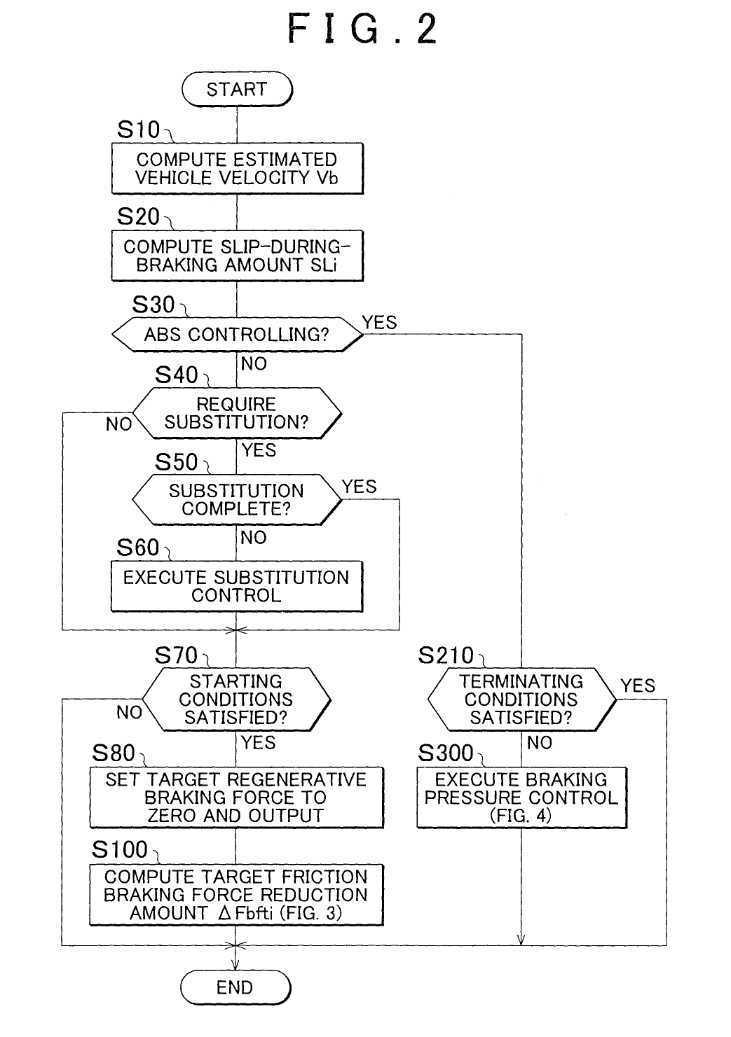

Next, a main routine of the anti-skid control which is performed on each of the wheels by the braking control device 48 in accordance with the embodiment will be described with reference to the flowchart shown in FIG. 2. The control following the flowchart shown in FIG. 2 is started by closing an ignition switch which is not shown and repeatedly executed for a prescribed period of time.

First in step 10, according to the state and drive type of the vehicle, the value which is closest to an actual vehicle velocity is selected as the estimated vehicle velocity Vb from among the wheel velocities Vwi of each of the wheels. The estimated vehicle velocity Vb may be computed by an arbitrary known method.

In step 20, the slip-during-braking amount SLi (i=fl, fr, rl, rr) of each of the wheels is computed on the basis of the estimated vehicle velocity Vb and the wheel velocity Vwi of each of the wheels. The slip-during-braking amount SLi is the difference (Vb−Vwi) between the estimated vehicle velocity Vb and the slip-during-braking amount. SLi.

In step 30, a determination is made whether the anti-skid control (ABS control) is being performed. If the determination is YES in step 30, the process progresses to step 210. If the determination is NO in step 30, the process progresses to step 40.

In step 40, a determination is made about whether substitution control in which the friction braking force is substituted for the regenerative braking force, that is, whether the slip-during-braking amount SLi of a wheel is equal to or larger than the first threshold value SL1. If the determination is NO in step 40, the process progresses to step 70. If the determination is YES in step 40, the process progresses to step 50.

In step 50, a determination is made about whether the substitution controlling has been completed. If the determination is YES in step 50, the process progresses to step 70. If the determination is NO in step 50, the process progresses to step 60.

In step 60, the target regenerative braking force (the front wheel target regenerative braking force Fbrtf or the rear wheel target regenerative braking force Fbrtr) of either the front wheels or rear wheels that includes the particular wheel, of which the slip-during-braking amount SLi is equal to or larger than the first threshold value SL1, is gradually lowered at a preset reduction rate. Further, the target friction braking force Fbfti of either the front wheels or rear wheels that includes the particular wheel is increased by the reduced amount of the target regenerative braking force, thereby executing the substitution control.

In step 70, a determination is made about whether conditions for starting the anti-skid control are satisfied with respect to the particular wheel. If the determination is NO in step 70, the control routine shown in FIG. 2 is then temporarily terminated. If the determination is YES in step 70, the process progresses to step 80. In this case, for example, when the estimated vehicle velocity Vb is equal to or larger than a control starting reference value Vbs (a positive constant) and the slip-during-braking amount SLi of the particular wheel is equal to or larger than a second reference value SL2, it may be determined that the conditions for starting the anti-skid control are satisfied with respect to the particular wheel.

In step 80, the target regenerative braking force (the front wheel target regenerative braking force Fbrtf or the rear wheel target regenerative braking force Fbrtr) of either the front wheels or rear wheels that includes the particular wheel is set to zero, and the signal indicating its target regenerative braking force is output to the engine control unit 36.

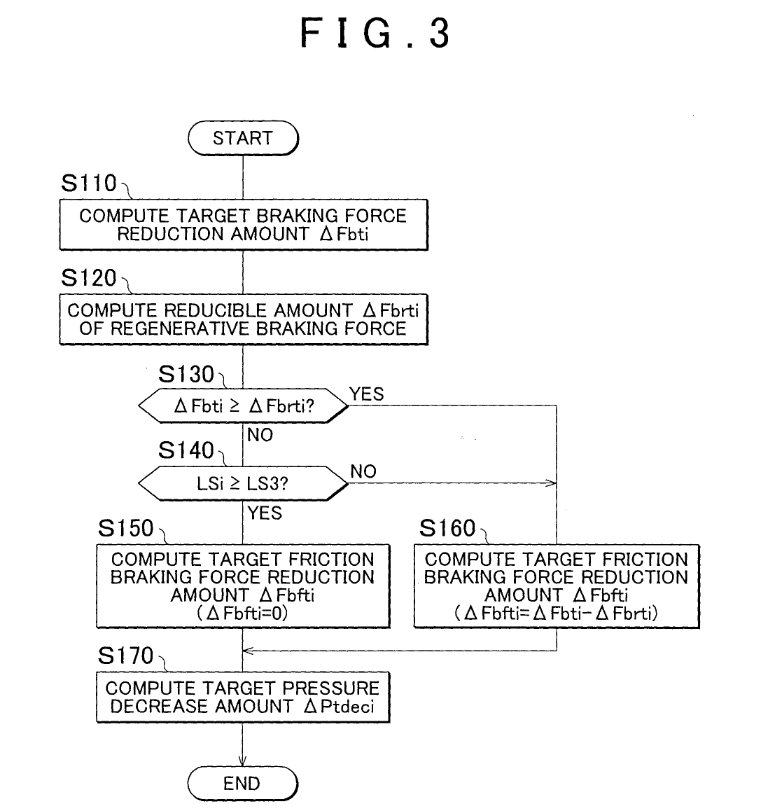

In step 100, following the flowchart shown in FIG. 3, a target friction braking force reduction amount ΔFhfti of the particular wheel for reducing the slip during braking of the particular wheel is computed.

In step 210, a determination is made about whether conditions for terminating the anti-skid control are satisfied with respect to the particular wheel. If the determination is YES in step 210, the control routine shown in FIG. 2 is terminated. If the determination is NO in step 210, the process progresses to step 300. The conditions for terminating the anti-skid control may be arbitrary conditions such that the slip-during-braking amount SLi of the particular wheel is equal to or smaller than a termination reference value, that the vehicle velocity is equal to or slower than a reference value, and that the master cylinder pressure Pm is equal to or lower than a reference value.

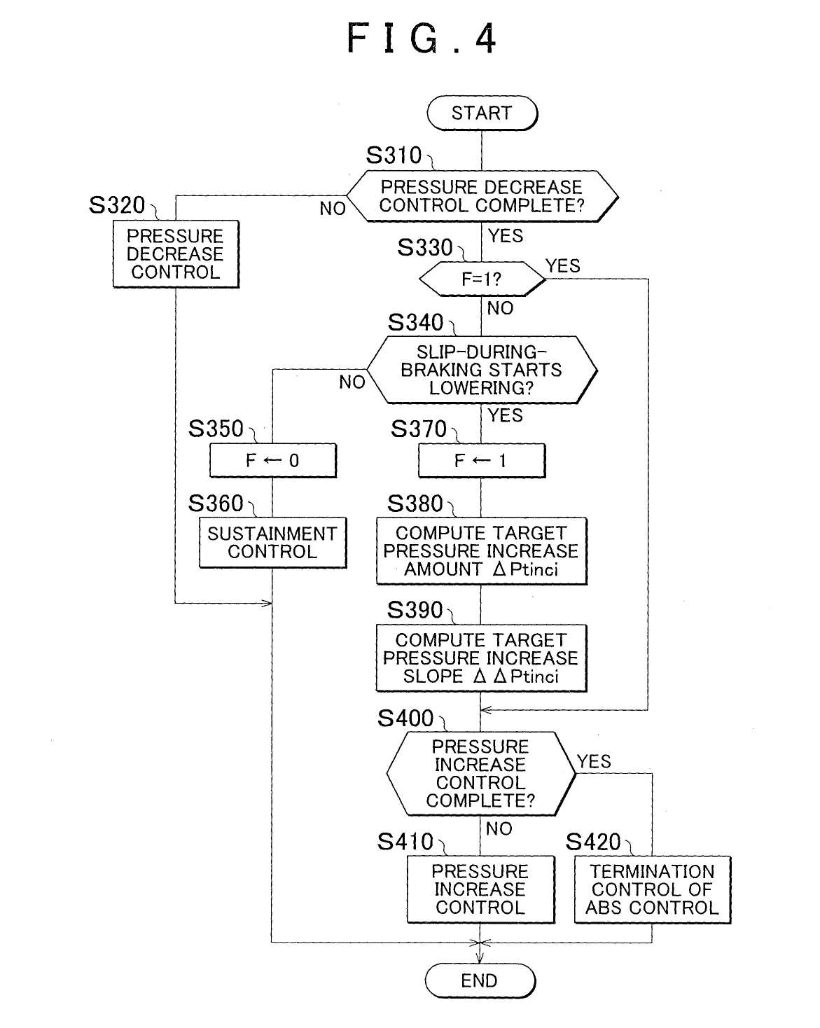

In step 300, following the flowchart shown in FIG. 4, the braking pressure Pi of the particular wheel is controlled to be reduced and thereafter to be increased. Accordingly, the braking force of the particular wheel is controlled so that the slip-during-braking amount decreases.

Next, a subroutine for computing the target friction braking force reduction amount will be described with reference to the flowchart shown in FIG. 3.

First in step 110, the target braking force reduction amount ΔFbti for reducing the slip during braking of the particular wheel is computed on the basis of the slip-during-braking amount SLi of the wheel. The target braking force reduction amount ΔFbti is computed such that it becomes larger as the slip-during-braking amount SLi becomes larger.

In step 120, the regenerative braking force Fbrf or Fbrr generated by the regenerative braking device (the front wheel regenerative braking device 14 or the rear wheel regenerative braking device 16) corresponding to either the front wheels or rear wheels that include the particular wheel is computed as a reducible amount ΔFbrti of the regenerative braking force.

In step 130, a determination is made about whether the target braking force reduction amount ΔFbti is equal to or larger than the reducible amount ΔFbrti of the regenerative braking force. If the determination is YES in step 130, the process progresses to step 160. If the determination is NO in step 130, the process progresses to step 140.

In step 140, a determination is made about whether the slip-during-braking amount SLi of the particular wheel is equal to or larger than a third threshold value SL3 (a positive constant larger than SL2). If the determination is NO in step 140, the process progresses to step 160. If the determination is. YES in step 140, the process progresses to step 150.

In a case where the determination is NO in step 140, if the target friction braking force reduction amount ΔFbfti is computed out by subtracting the reducible amount ΔFbrti of the regenerative braking force from the target braking force reduction amount ΔFbti; the target friction braking force reduction amount ΔFbfti becomes a negative value. In this case, the braking force of the particular wheel should be increased. However, because the slip-during-braking amount is large when the determination is YES in step 140, the target friction braking force reduction amount ΔFbfti is set to zero in step 150, and the process thereafter progresses to step 170.

In step 160, the target friction braking force reduction amount ΔFbfti is computed out by subtracting the reducible amount ΔFbrti of the regenerative braking force from the target braking force reduction amount ΔFbti, and the process thereafter progresses to step 170.

In step 170, a target pressure decrease amount ΔPtdeci (i=fl, fr, rl, rr) for reducing the friction braking force Fbti of the particular wheel by the target friction braking force reduction amount ΔFbfti is computed. If the determination is YES in step 130, the target friction braking force reduction amount ΔFbfti computed out in step 160 is a positive value, and the computed target pressure decrease amount ΔPtdeci in step 1701 is also a positive value. Accordingly, the target pressure decrease amount ΔPtdeci is computed as a target value of a reduction amount of the braking pressure Pi. On the other hand, if the determination is NO in step 140, the target friction braking force reduction amount ΔFbfti computed out in step 150 is a negative value, and the target pressure decrease amount ΔPtdeci computed out in step 170 is also a negative value. Accordingly, the target pressure decrease amount ΔPtdeci is computed as a target value of an increasing amount of the braking pressure Pi.

Next, a subroutine for controlling the braking pressure will be described with reference to the flowchart shown in FIG. 4.

In step 310, a determination is made about whether pressure decrease control is complete, that is, whether the braking pressure Pi of the particular wheel has been reduced by the target pressure decrease amount ΔPtdeci after the anti-skid control is started. Then, if the determination is YES in step 310 the process progresses to step 330. If the determination is NO in step 310, the process progresses to step 320. In step 320, the braking pressure Pi of the particular wheel is decreased at a preset pressure decrease slope.

In step 330, a determination is made about whether flag F is 1, that is, whether the braking pressure Pi of the particular wheel is being controlled to increase. If the determination is YES in step 330, the process progresses to step 400. If the determination is NO in step 330, the process progresses to step 340.

In step 340, a determination is made about whether the slip-during-braking of the particular wheel has started lowering. If the determination is YES in step 340, the process progresses to step 370. If the determination is NO in step 340, the process progresses to step 350. For example, in the case that a state where the slip-during-braking amount SLi of the particular wheel is smaller than the previous value continues for preset cycles or longer, the determination is made that the slip-during-braking has started lowering.

In step 350, flag F is reset to 0. In step 360, the control is made such that the braking pressure Pi of the particular wheel is sustained without change, thereby sustaining constant braking force.

In step 370, flag F is set to 1. In step 380, a target pressure increasing amount ΔPtinci of the braking pressure Pi of the particular wheel is computed out by multiplying K (K is larger than zero but smaller than one, for example, a constant approximately 0.7) by the target pressure decrease amount ΔPtdeci.

In step 390, a target pressure increase slope ΔΔPtinci of the braking pressure Pi of the particular wheel is computed. The target pressure increase slope ΔΔPtinci is computed out as a larger value as the target pressure increasing amount ΔPtinci becomes larger. The target pressure increase slope ΔΔPtinci is also computed out as a larger value as the lowering rate of the slip-during-braking of the particular wheel becomes higher.

In step 400, a determination is made about whether pressure increase control is complete, that is, whether the braking pressure Pi of the particular wheel has been increased. Then, if the determination is YES in step 400, the process progresses to step 420. If the determination is NO in step 400, the process progresses to step 410.

In step 410, the braking pressure Pi of the particular wheel is increased at the target pressure increase slope ΔΔPtinci. In step 420, to terminate the anti-skid control, the braking pressure Pi on the particular wheel is increased at a pressure increase slope ΔΔPtendi smaller than the target pressure increase slope ΔΔPtinci. In this case, the pressure increase slope ΔΔPtendi is variably set such that the pressure increase slope ΔΔPtendi becomes a larger value as the friction coefficient of the road surface becomes larger. The pressure increase slope ΔΔPtendi becomes a smaller value as the increase rate of the slip-during-braking amount SLi according to the increase in the braking pressure Pi becomes higher.

As it is understood from the above description, when the slip-during-braking amount SLi of the particular wheel increases and becomes equal to or larger than the first threshold SL1, it is determined YES in step 40, and it is determined NO in step 50. Accordingly, step 60 is executed. As a result, the regenerative braking force of the particular wheel, of which the slip-during-braking amount SLi is equal to or larger than the first threshold SL1, is reduced, and the friction braking force of the particular wheel is increased to cover the reduction in the regenerative braking force. In the above manner, the friction braking force is gradually substituted for the regenerative braking force in the particular wheel.

When the slip-during-braking amount SLi of the particular wheel further increases and becomes equal to or larger than the second threshold value SL2, it is determined YES in step 70. Then, in step 80, the regenerative braking force of the particular wheel is reduced to zero. In addition, in step 100, the target friction braking force reduction amount ΔFbfti of the particular wheel for reducing the slip-during-braking of the particular wheel is computed. Further, it is determined YES in step 30, thereby starting the anti-skid control for lowering the braking force and thus reducing the slip during braking of the particular wheel.

Following the flowchart shown in FIG. 3, the target friction braking force reduction amount ΔFbfti is computed on the basis of the slip-during-braking amount SLi of the particular wheel and the comparison result between the target braking force reduction amount ΔFbti for reducing the slip during braking of the particular wheel and the reducible amount ΔFbrti of the regenerative braking force.

First, a case (1) will be described that the regenerative braking force remains before the anti-skid control starts, and the target braking force reduction amount ΔFbti is equal to or larger than the reducible amount ΔFbrti of the regenerative braking force. It is determined YES in step 130, and in step 160, the target friction braking force reduction amount ΔFbfti is computed by subtracting the reducible amount ΔFbrti of the regenerative braking force from the target braking force reduction amount ΔFbti. In other words, the target friction braking force reduction amount ΔFbfti is computed so that the sum of the reduction amount of the friction braking force and the reduction amount of the regenerative braking force is equal to the target braking force reduction amount ΔFbti.

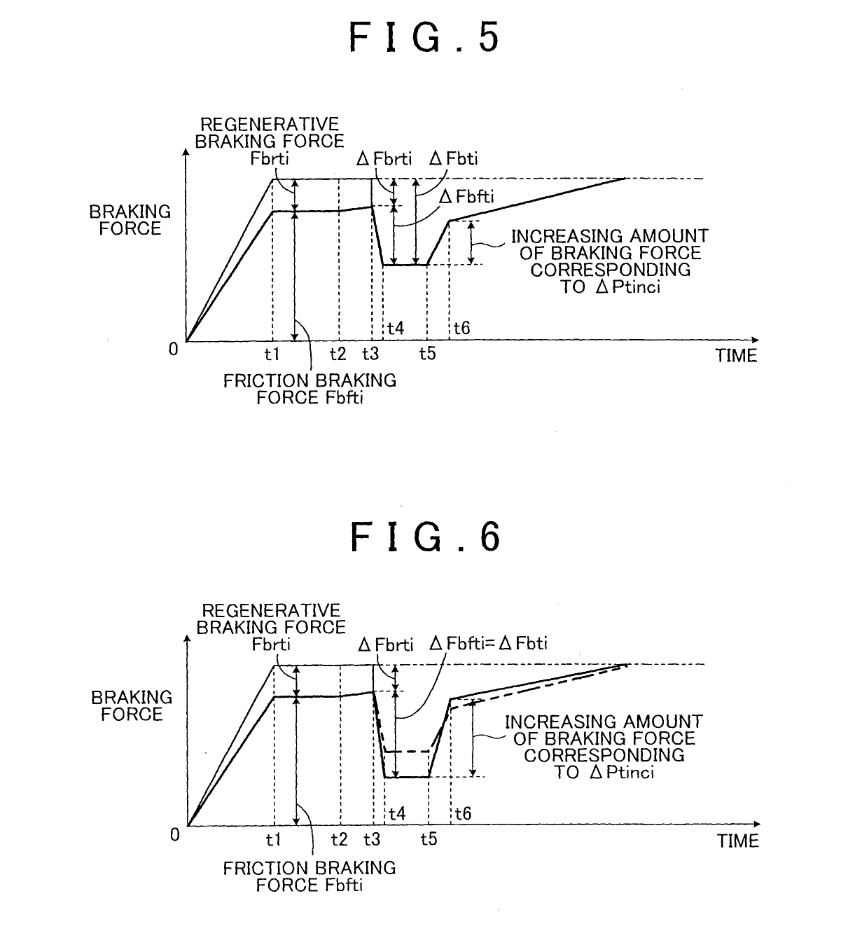

FIG. 5 is a graph representing an example of changes in the friction braking force and the regenerative braking force in the braking force control device in accordance with the above embodiment in a case that the regenerative braking force remains when the anti-skid control starts and the target braking force reduction amount ΔFbti is equal to or larger than the reducible amount ΔFbrti of the regenerative braking force. In FIG. 5, it is given that the braking operation amount by the driver increases at a constant increase rate until point t1 and the braking operation amount is sustained at a constant value after point t1. Point t2 is the point at which the determination in step 40 about whether the substitution control is necessary changes from NO to YES. Point t3 is the point at which the determination in step 70 about whether the conditions for starting the anti-skid control are satisfied changes from NO to YES. Such changes occur in the same manner in FIGS. 6 to 8.

As shown in FIG. 5, according to this embodiment, the reduction in the braking pressure starts at point t3. Then at point t4, the pressure decrease for reducing the braking pressure Pi of the particular wheel by the target pressure decrease amount ΔPtdeci completes. At point t5, the slip during braking of the particular wheel starts lowering, and at point t6 the pressure increase in the braking pressure Pi of the particular wheel is complete. Such changes also occur in the same manner in FIGS. 6 to 8.

From point t4 to point t5, the braking pressure Pi of the particular wheel is sustained at a constant value. From point t5 to point t6, the braking pressure Pi of the particular wheel is increased at the target pressure increase slope ΔΔPtinci. After point t6, the braking pressure Pi is increased at ΔΔPtendi smaller than the target pressure increase slope ΔΔPtinci.

FIG. 6 is a graph representing an example of changes in the friction braking force and the regenerative braking force in a conventional braking force control device in a case that the regenerative braking force remains when the anti-skid control starts and the target braking force reduction amount ΔFbti is equal to or larger than the reducible amount ΔFbrti of the regenerative braking force. In FIG. 6, the two-dot chain line indicates the change in the friction braking force in the embodiment shown in FIG. 5 for comparison.

In the conventional braking control device, regardless of whether the regenerative braking force remains at point t3 at which the anti-skid control starts, the braking pressure is decreased so that the friction braking force is reduced by the target braking force reduction amount ΔFbti. Accordingly, as shown in FIG. 6, in the case that the regenerative braking force remains at point t3 at which the anti-skid control starts, the friction braking force is excessively reduced by the braking force corresponding to the remaining regenerative braking force.

On the other hand, according to the embodiment, the target friction braking force reduction amount ΔFbfti is computed so that the sum of the reduction amount of the friction braking force and the reduction amount of the regenerative braking force is equal to the target braking force reduction amount ΔFbti. Therefore, in the case that the regenerative braking force remains at point t3 at which the anti-skid control starts, the braking force is reduced by the target friction braking force reduction amount ΔFbfti, and the excessive reduction in the braking force can be prevented.

Further, in the conventional braking force control device, the reference amount for computing the pressure increasing amount of the braking pressure after the braking pressure has been sustained is the reduction amount of the braking force after the anti-skid control has started, that is, the sum of the reduction amount of the regenerative braking force and the reduction amount of the friction braking force. Accordingly, in a case that the regenerative braking force is large when the anti-skid control starts, the pressure increasing amount becomes excessively large after the braking pressure has been sustained, and this may cause premature and excessive increase in the braking pressure.

However, according to the embodiment, regardless of whether the regenerative braking force remains, the reference value for computing the pressure increasing amount of the braking pressure after the braking pressure has been sustained is the reduction amount of the friction braking force after the anti-skid control has started. Therefore, even in the case that the regenerative braking force remains when the anti-skid control starts, the pressure increasing amount of the braking pressure after the braking pressure has been sustained can be prevented from becoming excessively large, thus allowing prevention of premature and excessive increase in the braking force.

Next, a case (2) will be described that the regenerative braking force remains when the anti-skid control starts, the target braking force reduction amount ΔFbti is smaller than the reducible amount ΔFbrti of the regenerative braking force, and the slip-during-braking amount SLi is smaller than the third threshold value SL3. In this case, the determinations are NO in steps 130 and 140 in the flowchart shown in FIG. 3. Then, in step 160, the target friction braking force reduction amount ΔFbfti is computed out as a negative value, and in step 170, the target pressure decrease amount ΔPtdeci is computed out as a negative value. As a result, the braking pressure is increased; in turn increasing the friction braking force.

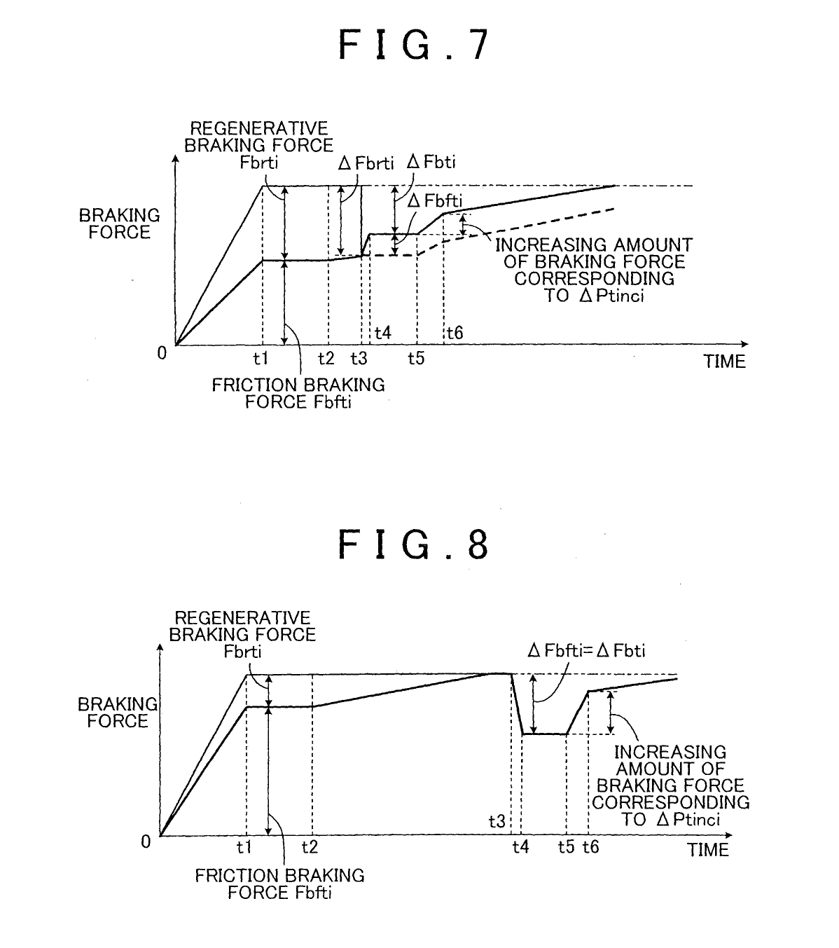

For example, as shown in FIG. 7, the regenerative braking force is reduced to zero at point t3. Until an increasing amount of the braking force of the particular wheel reaches the target pressure decrease amount ΔPtdeci, the braking force of the particular wheel keeps increasing at a preset increase slope. When the increasing amount of the braking force of the particular wheel reaches the target pressure decrease amount ΔPtdeci at point t4, the braking force of the particular wheel is sustained at a constant value until point t5.

Accordingly, the shortage of the braking force due to the reduction of the regenerative braking force to zero can be covered by the friction braking force. This allows prevention of excessive reduction in the braking force due to the reduction of the regenerative braking force to zero.

A case (3) will be described that the regenerative braking force remains when the anti-skid control starts, the target braking force reduction amount ΔFbti is smaller than the reducible amount ΔFbrti of the regenerative braking force, and the slip-during-braking amount SLi is equal to or larger than the third threshold value SL3. In this case, the determination is NO in step 130 and YES in step 140 in the flowchart shown in FIG. 3. In step 150, the target friction braking force reduction amount ΔFbfti is set to zero. In step 170, the target pressure decrease amount ΔPtdeci which should be computed out as a negative value is computed out as zero. Therefore, the friction braking force is not increased.

Accordingly, for example, as indicated by the broken line in FIG. 7, the braking pressure Pi on the particular wheel is sustained at a constant value from points t3 to t5, and the braking force Fbi of the particular wheel is thus sustained at a constant value. This allows effective reduction in the slip-during-braking of the wheel compared to the case (2) that the braking force is covered by the friction braking force.

A case (4) will be described that no regenerative braking force remains when the anti-skid control starts. In this case, since the reducible amount ΔFbrti of the regenerative braking force is computed out as zero in step 120, the determination is YES in step 130. In step, 160, the target friction braking force reduction amount ΔFbfti is computed out as the target braking force reduction amount ΔFbti, and in step 170, the target pressure decrease amount ΔPtdeci is thereby computed out as the value corresponding to the target braking force reduction amount ΔFbti.

Accordingly, since the regenerative braking force is not used for the computation of the target braking force reduction amount ΔFbti, the control of the friction braking force in this case is substantially the same as the case of the conventional braking force control device. In this case, the friction braking force and the regenerative braking force change as shown in FIG. 8, for example.

As it can be understood from the above description, according to the above-described embodiment, when the anti-skid control starts, a target change amount of the friction braking force can be set according to the comparison result between the regenerative braking force generated at the starting point of the anti-skid control and the requested amount of braking force reduction for the anti-skid control (the determination about whether a requested amount of braking force reduction for the anti-skid control is equal to or larger than the regenerative braking force generated at the starting point of the anti-skid control). Further, the regenerative braking force is reduced, and the friction braking force is changed on the basis of the target change amount. Accordingly, regardless of the regenerative braking force and the requested amount of braking force reduction, the friction braking force can be appropriately changed to reduce the slip during braking.

In addition, according to the above-described embodiment, when the anti-skid control starts, the target change amount of the friction braking force can be set so that the sum of the regenerative braking force generated at the starting point of the anti-skid control and the target change amount of the friction braking force is basically equal to the requested amount of braking force reduction for the anti-skid control. Further, the regenerative braking force is reduced, and the friction braking force is changed on the basis of the target change amount. Accordingly, regardless of the regenerative braking force and the requested amount of braking force reduction, the friction braking force can be appropriately changed to reduce the slip during braking.

In the foregoing, a particular embodiment in accordance with the present invention has been described in detail. However, the present invention is not limited to the above embodiment, but other various embodiments are possible within the scope of the present invention.

For example, in the above embodiment, when the slip-during-braking amount SLi of a wheel is equal to or larger than the first threshold value SL1, the substitution control is performed in which the friction braking force of the wheel is substituted for the regenerative braking force. However, the braking force control device may be applied to a vehicle which does not perform the substitution control.

Further, in the above embodiment, in step 140 in the flowchart shown in FIG. 3, the determination is made about whether the slip-during-braking amount SLi is equal to or larger than the third threshold value SL3, and depending on the determination result, the process for computing the target friction braking force reduction amount ΔFbfti is changed. However, the determination in step 140 may be omitted, and if the determination is NO in step 130, step 150 or 160 may be executed.

The target friction braking force reduction amount ΔFbfti may be variably set according to the slip-during-braking amount SLi such that if the determination is NO in step 130, the target friction braking force reduction amount ΔFbfti becomes larger as the slip-during-braking amount SLi becomes larger. For example, the target friction braking force reduction amount ΔFbfti may be computed on the basis of the slip-during-braking amount SLi and the value resulting from the subtraction of the reducible amount ΔFbrti of the regenerative braking force from the target braking force reduction amount ΔFbti.

In the above embodiment, when the anti-skid control starts, the braking pressure Pi of the wheel on which the anti-skid control is to be executed is decreased at the preset pressure decrease slope. However, for example, the pressure decrease slope may be variably set according to the slip-during-braking amount SLi such that the pressure decrease slope becomes larger as the slip-during-braking amount becomes larger.

Further, in the above embodiment, the regenerative braking devices 14 and 16 are provided for both the front and rear wheels. However, the braking force control device of the present invention may be applied to a vehicle having the regenerative braking device on either front wheels or rear wheels. The braking force control device of the present invention may be applied to a vehicle having the regenerative braking device on each of the wheels, such as an electric vehicle.

The requested amount of braking force reduction (the target braking force reduction amount ΔFbti, for example) requested in the anti-skid control may be set based on a degree of a slip during braking of a wheel.

the target change amount (the target friction braking force reduction amount ΔFbfti, for example) of the friction braking force in the anti-skid control may be set based on the difference between the requested amount of braking force reduction and the amount of regenerative braking force reduction (the reducible amount ΔFbrti of the regenerative braking force) by which the regenerative braking force is reduced when the anti-skid control starts. Then, the regenerative braking force may be reduced by the amount of regenerative braking force reduction and the friction braking force may be reduced based on the target change amount during the anti-skid control.

In such a case, when the amount of regenerative braking force reduction is larger than the requested amount of braking force reduction and the target change amount is set to be a negative value, the friction braking force may be increased based on the target change amount.

When the amount of regenerative braking force reduction is larger than the requested amount of braking force reduction and the target change amount is set to be a negative value, the magnitude of the target change amount may be variably set according to a degree of the slip during braking of a wheel on which the anti-skid control is performed such that the magnitude of the target change amount becomes larger as the degree of the slip during braking of the wheel is grater.

The friction barking force on a wheel on which the anti-skid control is performed may be reduced on the basis of the target change amount, the reduced friction braking force is sustained until a degree of the slip during braking of the wheel starts lowering, and the friction braking force on the wheel may be thereafter increased.

An increasing amount in the friction braking force after the reduced friction braking force has been sustained may be set based on the target change amount of the friction braking force.

A slope of increase in the friction braking force after the reduced friction braking force has been sustained may be set based on at least one of the target change amount of the friction braking force and the friction coefficient of a road surface.

1. A vehicle braking force control device, comprising
a controller that controls braking force of a wheel by controlling friction braking force generated by a friction braking device and regenerative braking force generated by regenerative braking devices and that performs anti-skid control based on a requested amount of braking force reduction by controlling the friction braking force and reducing the regenerative braking force by an amount of regenerative braking force-reduction, wherein:
the controller sets a target change amount of the friction braking force based on the requested amount of braking force reduction and the amount of regenerative braking force reduction;
the controller controls the friction braking force based on the target change amount when the controller reduces the regenerative braking force by the amount of regenerative braking force reduction;
the controller sets the target change amount so that a sum of the amount of regenerative braking force reduction and the target change amount is equal to the requested amount of braking force reduction;
if the requested amount of braking force reduction is smaller than the amount of regenerative braking force reduction, the controller increases the friction breaking force by the target change amount during the anti-skid control; and
if the requested amount of braking force reduction is smaller than the amount of regenerative braking force reduction and a slip amount during braking is equal to or larger than a threshold value, the controller sets the target change amount to zero.

2. The vehicle braking force control device according to claim 1, wherein
the controller sets the target change amount according to whether the requested amount of braking force reduction is equal to or larger than the amount of regenerative braking force reduction.

3. The vehicle braking force control device according to claim 1, wherein
if the requested amount of braking force reduction is smaller than the amount of regenerative braking force reduction, the controller sets the target change amount to an increasing amount that is equal to or smaller than a difference between the amount of regenerative braking force reduction and the requested amount of braking force reduction and that is equal to or larger than zero and increases the friction braking force by the increasing amount during the anti-skid control.

4. The vehicle braking force control device according to claim 1, wherein
if the requested amount of braking force reduction is equal to or larger than the amount of regenerative braking force reduction, the controller sets the target change amount to a lowering amount that is a difference between the requested amount of braking force reduction and the amount of regenerative braking force reduction and reduces the friction braking force by the lowering amount during the anti-skid control.

5. (canceled)

6. (canceled)

7. The vehicle braking force control device according to claim 1, wherein
if the requested amount of braking force reduction is equal to or larger than the amount of regenerative braking force reduction, the controller reduces the friction braking force by the target change amount during the anti-skid control.

8. (canceled)

9. The vehicle braking force control device according to claim 1, wherein the controller reduces the regenerative braking force to zero by reducing the regenerative braking force by the amount of regenerative braking force reduction during the anti-skid control.

10. A method for controlling vehicle braking force, the method comprising:
controlling braking force of a wheel by controlling friction braking force generated by a friction braking device and regenerative braking force generated by regenerative braking devices;
setting a requested amount of braking force reduction that is requested in anti-skid control;
setting an amount of regenerative braking force reduction by which the regenerative braking force is reduced during the anti skid control;
setting a target change amount of the friction braking force based on the requested amount of braking force reduction and the amount of regenerative braking force reduction; and
performing the anti-skid control by reducing the regenerative braking force by the amount of regenerative braking force reduction and controlling the friction braking force based on the target change amount, wherein:
the target change amount is set so that a sum of the amount of regenerative braking force reduction and the target change amount is equal to the requested amount of braking force reduction;
if the requested amount of braking force reduction is smaller than the amount of regenerative braking force reduction, the friction braking force is increased by the target change amount during the anti-skid control; and
if the requested amount of braking force reduction is smaller than the amount of regenerative braking force reduction and a slip amount during braking is equal to or larger than a threshold value, the target change amount is set to zero.

11. The method for controlling vehicle braking force according to claim 10, wherein
the target change amount is set according to whether the requested amount of braking force reduction is equal to or larger than the amount of regenerative force reduction.

12. The method for controlling vehicle braking force according to claim 10, wherein
the target change amount is set so that a sum of the amount of regenerative braking force reduction and the target change amount is equal to the requested amount of braking force reduction.
